(19) United States
(12) Patent Application Publication
(10) Pub. No.: US 2007/0080876 A1
(43) Pub. Date: Apr. 12, 2007

(54) Planar antenna and window glass sheet for automobiles

(75) Inventors: Osamu Kagaya, Chiyoda-ku (JP); Kiyoshi Oshima, Chiyoda-ku (JP); Koji Ikawa, Chiyoda-ku (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: ASAHI GLASS COMPANY, LIMITED, Chiyoda-ku (JP)

(21) Appl. No.: 11/527,624

(22) Filed: Sep. 27, 2006

(30) Foreign Application Priority Data
Sep. 28, 2005 (JP) 2005-281725

(51) Int. Cl. H01Q 1/32

(52) U.S. Cl. 343/713

(57) ABSTRACT

When it is assumed that there is a first imaginary straight line connecting between the center of gravity of the first antenna wire and the center of gravity of the second antenna wire, the first imaginary straight line is called a transverse line, and when it is assumed that there is a second imaginary line obtained by endlessly extending the transverse line, the second imaginary line is called an endless transverse line; when the center between closest portions of the first antenna wire and the second antenna wire is called an antenna center; independent conductor A is disposed on a side closer to the first antenna wire with respect to the antenna center; independent conductor B is disposed on a side closer to the second antenna wire with respect to the antenna center; and independent conductor A and independent conductor B are disposed on or in a dielectric substrate so that the endless transverse line passes through independent conductor A and independent conductor B or extends over or under independent conductor A and independent conductor B.

### BACKGROUND OF THE INVENTION

1. Field of the Invention

The present invention relates to a planar antenna, and in particular, relates to a planar antenna, which is appropriate to radio wave communication using a frequency from about 1 to about 30 GHz, in particular from about 1 to about 6 GHz, and which is appropriate to a glass antenna for vehicles. The present invention also relates to a window glass sheet for automobiles, which includes such a planar antenna.

2. Discussion of Background

The GPS (Global Positioning System), the ETC (Electric Toll Collection System) and other systems have been recently employed to communicate between an in-vehicle communication device and an external communication device by a radio wave in order to make vehicles run smoother.

For example, it may be considered that an in-vehicle antenna as shown in FIG. 13 is applied as the antenna for in-vehicle communication used in these systems (see, e.g., JP-A-2004-214820). In this prior art, a dielectric substrate has a radiating conductor 73 disposed thereon and also has a ground conductor 74 disposed thereon to surround the radiating conductor 73. When the wavelength of a radio wave for communication, which corresponds to a resonant frequency, is X, a pair of linear conductors 71 and 72 is disposed so as to be spaced from the outer edge of the ground conductor by a distance of (λ/2) or (λ/4). The dielectric substrate also has a linear conductor 75 disposed thereon for AM and FM broadcast bands. The linear conductor 72 is disposed between the ground conductor 74 and the linear conductor 75. The paired linear conductors 71 and 72 can block or reflect a radio wave transmitted on the dielectric substrate, improving an antenna gain.

However, this prior art discloses only two modes of provision of the paired linear conductors and provision of an annular conductor. This prior art is silent on the length of the linear conductors. Since this prior art is also silent on how to dispose the linear conductors in other kinds of antennas, there has been a problem that it is difficult to apply the prior art to other kinds of antennas.

When this prior art is applied to a window glass sheet of an automobile as a high frequency antenna, a radio wave, which is transmitted on the window glass sheet, cannot be blocked or reflected in a sufficient way, with the result that interference is caused between the antenna and a portion of the automobile body in the vicinity of the window glass sheet. As a result, plural null points are generated, causing a problem in that the directivity greatly varies from portion to portion.

### SUMMARY OF THE INVENTION

It is an object of the present invention to provide a planar antenna, which is capable of solving the above-mentioned problems of the prior art.

The present invention provides a planar antenna comprising:

a dielectric substrate having an antenna conductor disposed thereon or therein, the antenna conductor comprising a monopole antenna; and

two conductors, each of which is spaced from the antenna conductor by a distance, and which are called independent conductor A and independent conductor B, respectively;

wherein when an imaginary straight line, which passes through the center of gravity of the antenna conductor or the center of the antenna conductor and extends in parallel with a longitudinal direction of the antenna conductor, is called an endless transverse line;

the antenna conductor is formed in such a shape and a size to have an antenna gain in the longitudinal direction;

independent conductor A is disposed on one of both sides of the antenna conductor, and independent conductor B is disposed on the other side of the antenna conductor; and

independent conductor A and independent conductor B are disposed on or in the dielectric substrate so that the endless transverse line passes through independent conductor A and independent conductor B or extends over or under independent conductor A and independent conductor B.

The present invention also provides a planar antenna comprising:

a dielectric substrate having a first antenna wire and a second antenna wire disposed thereon or therein so as to be close to each other, each of the first antenna wire and the second antenna wire being formed in a loop shape; and

two conductors, each of which is spaced from the first antenna wire and the second antenna wire by a distance, and which are called independent conductor A and independent conductor B, respectively;

wherein when it is assumed that there is a first imaginary straight line connecting between the center of gravity of the first antenna wire and the center of gravity of the second antenna wire or connecting between the center of the first antenna wire and the center of the second antenna wire, the first imaginary straight line is called a transverse line, and when it is assumed that there is a second imaginary line obtained by endlessly extending the transverse line, the second imaginary line is called an endless transverse line;

when the center between closest portions of the first antenna wire and the second antenna wire is called an antenna center,

independent conductor A is disposed on a side closer to the first antenna wire with respect to the antenna center;

independent conductor B is disposed on a side closer to the second antenna wire with respect to the antenna center; and

independent conductor A and independent conductor B are disposed on or in the dielectric substrate so that the endless transverse line passes through independent conductor A and independent conductor B or extends over or under independent conductor A and independent conductor B.

The present invention also provides a planar antenna comprising:

a window glass sheet having a first antenna wire and a second antenna wire disposed thereon or therein so as to be close to each other, each of the first antenna wire and the second antenna wire being formed in a loop shape and being disposed in the vicinity of a vehicle opening edge for a window;

wherein when it is assumed that there is an imaginary straight line connecting between the center of gravity of the first antenna wire and the center of gravity of the second antenna wire or connecting between the center of the first antenna wire and the center of the second antenna wire, the imaginary straight line is called a transverse line;

the window glass sheet has independent conductor C disposed thereon or therein; independent conductor C is formed in a shape having a longitudinal direction; and independent conductor C, the first antenna wire and the second antenna wire are disposed so that each of the longitudinal direction of independent conductor C and the transverse line extends in parallel or substantially parallel with the vehicle opening edge for a window and that the first antenna wire and the second antenna wire are disposed between independent conductor C and the vehicle opening edge for a window.

The present invention also provides a window glass sheet for an automobile, comprising a dielectric substrate, the dielectric substrate having the above-mentioned planar antenna disposed thereon or therein.

The present invention is advantageous in terms of antenna gain as an antenna for a circularly-polarized wave because of adopting the above-mentioned structure. The present invention is also advantageous in terms of axial ratio and non-directivity and can make the planar antenna compact. When the present invention is applied to a window glass sheet for an automobile, the present invention is advantageous in terms of insuring sight and is also advantageous in terms of reduced cost and productivity. The present invention is also applicable to an antenna for a vertically polarized wave or a horizontally polarized wave.

An electric field is generated from an end portion or a curved portion of the antenna conductor and an antenna wire or the like, and it is supposed that the electric field propagates in such a direction that the endless transverse line extents.

For this point of view, when independent conductor A and independent conductor B are disposed on the dielectric substrate, it is supposed that it is possible to prevent interference from being caused between a metal body existing in the vicinity of the dielectric substrate and the antenna conductor or an antenna wire. When independent conductor A and independent conductor B are disposed on an automobile window glass sheet, it is supposed that it is possible to prevent interference from being caused between a portion of the car body in the vicinity of the window glass sheet and the antenna conductor or an antenna wire.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a plan view of the planar antenna according to an embodiment of the present invention, wherein one side of a window glass sheet with antenna wires disposed thereon or therein is shown;

FIG. 2 is a plan view of another embodiment of the present invention, which is different from the embodiment shown in FIG. 1;

FIG. 3 is a plan view of another embodiment of the present invention, wherein a first antenna wire and a second antenna wire are formed in a different shape from those shown in FIG. 1;

FIG. 4 is a plan view showing another embodiment of a portion of the planar antenna except for the independent conductors shown in FIG. 1, which is formed in a different shape;

FIG. 5 is a plan view showing another embodiment of a portion of the planar antenna except for the independent conductors shown in FIG. 1, which is formed in a different shape;

FIG. 6 is a plan view showing another embodiment of a portion of the planar antenna except for the independent conductors shown in FIG. 1, which is formed in a different shape;

FIG. 7 is a plan view showing the first antenna wire shown in each of FIGS. 1 and 2;

FIG. 8 is a plan view of another embodiment, which is different from the embodiments shown in FIGS. 1 and 2;

FIG. 9 is the directional pattern of Example 1;

FIG. 10 is the directional pattern of Example 2;

FIG. 11 is the directional pattern of Example 3;

FIG. 12 is the directional pattern of Example 4; and

FIG. 13 is a plan view of a conventional planar antenna.

### DETAILED DESCRIPTION OF THE INVENTION

Now, the planar antenna according to the present invention will be described in detail based on preferred embodiments, which are shown in the accompanying drawings.

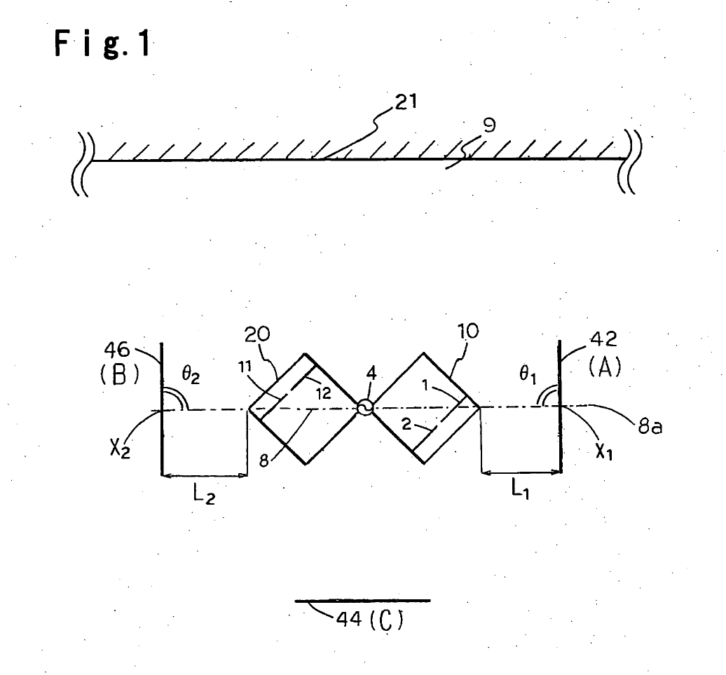

FIG. 1 is a plan view of the planar antenna according to an embodiment of the present invention, wherein one side of a window glass sheet with antenna wires disposed thereon or therein is shown.

In FIG. 1, reference numerals 1 and 2 designates a pair of coupling branch lines, reference numeral 4 designates a power source, reference numeral 8 designates an imaginary transverse line (a chain line in FIG. 1), reference numeral 8a designates an imaginary endless transverse line, reference numeral 9 designates an automobile window glass sheet as a dielectric substrate, reference numeral 10 designates a first antenna wire, reference numerals 11 and 12 designate a pair of coupling branch lines, reference numeral 20 designates a second antenna wire, reference numeral 21 designates a vehicle opening edge to fit the window glass sheet therein, references A and B designate conductors (hereinbelow, referred to as independent conductors), reference C designates a conductor disposed as required (hereinbelow, referred to as independent conductor), reference numeral 42 designates independent conductor A, reference numeral 44 designates independent conductor C, reference numeral 46 designates independent conductor B, reference X₁ designates a point where the endless transverse line 8a passes through independent conductor A or extends over or under independent conductor A, reference X₂ designates a point where the endless transverse line 8a passes through independent conductor B or extends over or under independent conductor B, reference L₁ designates the shortest distance between the point X₁ and the first antenna wire 10, reference L₂ designates the shortest distance between the point X₂ and the second antenna wire 20, reference θ₁ designates a smaller one of the angles formed at the point X₁, by the endless transverse line 8a and a straight portion of independent conductor A, and reference θ₂ designates a smaller one of the angles formed at the point X₂ by the endless transverse line 8a and a straight portion of independent conductor B.

In the embodiment shown in FIG. 1, when a radio wave is received, the radio wave comes from the backside of the sheet showing FIG. 1, and the electric field generated by a circularly polarized wave of the radio wave is counterclockwise rotated in a direction to see the radio wave coming (direction to see the backside of the sheet showing FIG. 1 from in front of the sheet showing FIG. 1). In other words, the radio wave is a left-handed circularly polarized wave.

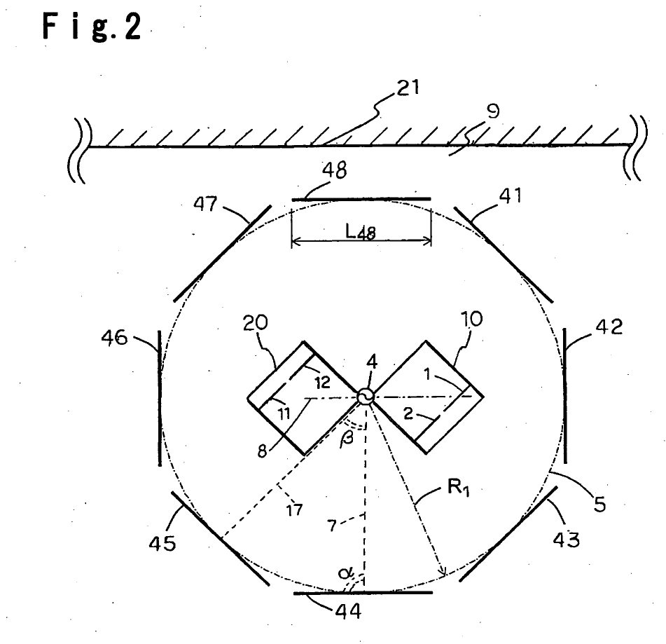

Provided that the window glass sheet 9 comprises a vehicle window glass sheet in the embodiment shown in FIG. 1, the window glass sheet is seen from the car interior side. Although FIG. 1 is a view seen from the inside of the vehicle, FIG. 1 may be considered as being view seen from outside the vehicle in some cases. This is also applicable to the embodiment shown in FIG. 2 and described later.

In the embodiment shown in FIG. 1, the first antenna wire 10, which is formed in a loop shape, and the second antenna wire 20, which is also formed in a loop shape, are disposed on the window glass sheet 9 so as to be close to each other. Independent conductor A and independent conductor B are disposed on the window glass sheet 9 so as to be spaced from the first antenna wire 10 and the second antenna wire 20 by a certain distance, respectively.

It is preferred from the viewpoint of improving a communication property that the first antenna wire 10 and the second antenna wire 20 be formed in the same shape or substantially the same shape as or in a similar shape to each other except for the directions to dispose both antenna wires on the window glass sheet 9. This is also applicable to the embodiment shown in FIG. 2 and described later.

The paired coupling branch lines 1 and 2 form a first capacitive coupling wire, and the paired coupling branch lines 11 and 12 form a second capacitive coupling wire. The first capacitive coupling wire and the second capacitive coupling wire are disposed as required. When it is assumed that there is a first imaginary straight line connecting between the center of gravity of the first antenna wire 10 and the center of gravity of the second antenna wire 20, or when it is assumed that there is a first imaginary straight line connecting between the center of the first antenna wire 10 and the center of the second antenna wire 20, this first imaginary straight line is called the transverse line 8. When it is assumed that there is a second imaginary straight line obtained by endlessly extending the transverse line 8, this second imaginary straight line is called the endless transverse line 8a.

The center between the closest portions of the first antenna wire 10 and the second antenna wire 20 is called an antenna center. Independent conductor A is disposed on a side close to the first antenna conductor 10 with respect to the antenna center. Independent conductor B is disposed on a side close to the second antenna wire with respect to the antenna center.

Independent conductor A and independent conductor B are disposed on the window glass sheet 9 so that the endless transverse line 8a passes through independent conductor A and independent conductor B or extends over or under independent conductor A and independent conductor B. In the embodiment shown in FIG. 1, the antenna center exists at the position where the power source 4 is located. By adopting such arrangement, it is possible to prevent a null point from being generated, with the result that the planar antenna is made as being a substantially non-directional antenna.

In the embodiment shown in FIG. 1, independent conductor A and independent conductor B have straight portions at the point X₁ and the point X₂, respectively. However, the present invention is not limited to this mode. Only one of independent conductor A and independent conductor B may have such straight portions at the point X₁ or the point X₂. At least one of independent conductor A and independent conductor B may have a curved portion at the point X₁ or the point X₂.

In the embodiment shown in FIG. 1, the smaller one θ₁ of the angles formed by the endless transverse line 8a and the straight portion of independent conductor A, and the smaller one θ₂ of the angles formed by the endless transverse line 8a and the straight portion of independent conductor B are 90 deg. This arrangement is preferred from the viewpoint of improving an antenna gain. However, the present invention is not limited to this mode. It is preferred that the angle θ₁ and the angle θ₂ be 72 to 108 deg, particularly 81 to 99 deg, in consideration of the presence of allowable tolerance.

In the embodiment shown in FIG. 1, each of independent conductor A and independent conductor B is formed in a linear shape. When each of independent conductor A and independent conductor B has a curved portion at a position where the endless transverse line 8a passes through independent conductor A or independent conductor B or extends over or under independent conductor A or independent conductor B, the above-mentioned condition is applied to the angle θ₁, providing that a smaller one of the angles formed by the endless transverse line 8a and an imaginary tangent to the curved portion of independent conductor A at the position corresponds to the angle θ₁. The above-mentioned condition is also applied to the angle θ₂, providing that a smaller one of the angles formed by the endless transverse line 8a and an imaginary tangent to the curved portion of independent conductor B at the position corresponds to the angle θ₂.

Although each of independent conductor A and independent conductor B comprises a linear conductor in the embodiment shown in FIG. 1, the present invention is not limited to this mode. Each of independent conductor A and independent conductor B may comprise a band-like conductor, a substantially band-like conductor, an island-like conductor or the like.

When each of independent conductor A and independent conductor B comprises an island-like conductor or the like, and when each of both independent conductors is formed in a shape having a longitudinal direction, it is preferred that the smaller one of the angles formed by the endless transverse line 8a and the longitudinal direction of independent conductor A be 72 to 108 deg, particularly 81 to 99 deg. It is also preferred that the smaller one of the angles formed by the endless transverse line 8a and the longitudinal direction of independent conductor B be 72 to 108 deg, particularly 81 to 99 deg. The longitudinal direction means a direction having the maximum width in each of independent conductor A and independent conductor B.

When a radio wave for communication has a wavelength of λ₀ in air, it is preferred that each of L₁ and L₂ be 10 mm to 0.51λ₀. When each of L₁ and L₂ is 10 mm or above, independent conductor A and the first antenna wire 10 are unlikely to be capacitively coupled together, and independent conductor B and the second antenna wire 20 are also unlikely to be capacitively coupled together, improving an antenna gain, in comparison with a case where each of L₁ and L₂ is less than 10 mm.

When each of L₁ and L₂ is 0.51λ₀ or below, the antenna is likely to be non-directional in comparison with a case where each of L₁ and L₂ is beyond 0.51λ₀. Each of L₁ and L₂ more preferably ranges from 20 mm to 0.41λ₀. Each of L₁ and L₂ particularly preferably ranges from 25 mm to 0.38λ₀.

This condition is preferably applied to a case where the radio wave for communication has a frequency ranging from.1 to 6 GHz. This condition is more preferably applied to a case where the frequency ranges from 2.10 to 2.65 GHz.

In the embodiment shown in FIG. 1, independent conductor C is also disposed on the window glass sheet 9, and independent conductor C is disposed so that independent conductor C extends in parallel or substantially parallel with the vehicle opening edge 21 for a window. In other words, independent conductor C is disposed so that the independent conductor is formed in a shape having a longitudinal direction, and that the longitudinal direction of independent conductor extends in parallel or substantially parallel with the vehicle opening edge 21 for a window. The vehicle opening edge for a window is the peripheral edge of a vehicle opening in which the window glass sheet 9 is fitted, which serves as vehicle grounding, and which is made of a conductive material, such as metal.

The first antenna wire 10 and the second antenna wire 20 are disposed so that the transverse line 8 extends in parallel or substantially parallel with the vehicle opening edge 21 for a window and that the first antenna wire 10 and the second antenna wire 20 are disposed between the vehicle opening edge 21 for a window and independent conductor C. This arrangement is preferred in terms of improved antenna gain. However, the present invention is not limited to this mode. The first antenna wire 10 and the second antenna wire 20 may be disposed so that the transverse line 8 does not extend in parallel or substantially parallel with the vehicle opening edge 21 for a window. Independent conductor C may be omitted.

Even if the first antenna wire 10 and the second antenna wire 20 are sandwiched between independent conductor C and the vehicle opening edge 21 for a window as stated above without disposing independent conductor A and independent conductor B unlike in the embodiment shown in FIG. 1, it is helpful to improve non-directivity.

FIG. 2 is a plan view of another embodiment, which is different from the embodiment shown in FIG. 1, wherein one side of a dielectric substrate with antenna wires disposed thereon or therein is shown.

In FIG. 2, reference numeral 5 designates an imaginary circle having a radius of R₁, reference numeral 7 designates an imaginary straight line, reference numerals 41 to 48 designates conductors (called first to eighth independent conductors, respectively), reference L₄₈ designates the length of the eighth independent conductor 48, and references α and β designate angles.

In the embodiment shown in FIG. 2, the eight conductors (the first to eighth independent conductors 41 to 48) are disposed so as to surround the first antenna wire 10 and the second antenna wire 20 and to be spaced from the first antenna wire 10 and the second antenna wire 20. The plural independent conductors can be disposed to improve an antenna gain. The second independent conductor 42, the fourth independent conductor 44 and the sixth independent conductor 46 in FIG. 2 correspond to independent conductor A, independent conductor C and independent conductor B in FIG. 1, respectively.

The number of the independent conductors is not limited to eight as in the embodiment shown in FIG. 2. The planar antenna can is operable as long as plural independent conductors are disposed. In the embodiment shown in FIG. 2, the independent conductors 41 to 48 are disposed so as to surround the first antenna wire 10 and the second antenna wire 20.

When it is assumed that there is the imaginary circle having a radius of R₁ and having the center located at the antenna center, it is preferred that a portion or the entire portion of each of the plural independent conductors except for independent conductor A and independent conductor B be disposed in a doughnut-like region having a radius of R₁=(0.3 to 0.68)·λ₀. When R₁ is 0.68·λ₀ or below in this case, the antenna gain is improved since the electric field converges in a substantially perpendicular direction to the dielectric substrate without dispersing. When R₁ is 0.3·λ₀ or above, the antenna gain is improved since the antenna is likely to be matched with a receiver or a transmitter in terms of impedance.

It is preferred that all the plural independent conductors except for independent conductor A and independent conductor B satisfy this condition. However, when at least one of the plural independent conductors except for independent conductor A and independent conductor B satisfies this condition, the planar antenna is operable.

It is preferred that a main portion, the entire portion, the center or the center of gravity of at least one of the plural independent conductor except for independent conductor A and independent conductor B be disposed in the doughnut-like region having a radius of R₁=(0.3 to 0.68)·λ₀. R₁ has a preferable range of (0.36 to 0.66)·λ₀. R₁ has a more preferable range of (0.40 to 0.65)·λ₀.

In the present invention, in a case where each of the plural independent conductors is formed in a linear shape, where each of the independent conductors formed in s such a linear shape has a conductor length of L_{C}, and where the dielectric substrate comprises a material having a shortening coefficient of wavelength of k, when both formulae of λ_{g}=λ₀·k and k=0.51 are established, it is preferred that one or more of the independent conductors formed in such a linear shape satisfy the formula of L_{C}/λ_{g}=0.2 to 0.65. It is possible to improve the antenna gain in this range in comparison with other ranges. However, the present invention is not limited to this mode. The planar antenna is operable as long as one or more of the independent conductors formed in such a linear shape satisfies the formula of L_{C}/λ_{g}=0.2 to 0.65 in a case where at least one of the plural independent conductors is formed in a linear shape.

The value of L_{C}/λ_{g} preferably ranges from 0.27 to 0.62, and the value of L_{C}/λ_{g} more preferably ranges from 0.33 to 0.60 and particularly preferably ranges from 0.37 to 0.56.

In a case where at least one of the plural independent conductors includes a portion formed in a shape except for such a linear shape in the present invention, when one of the independent conductors has the maximum width of L_{CM}, when the dielectric substrate comprises a material having a shortening coefficient of wavelength of k, and when the formula of λ_{g}=λ₀·k is established, the formula of L_{CM}/λ_{g}=0.2 to 0.65 is established. It is possible to improve the antenna gain in this range in comparison with other ranges. The value of L_{CM}/λ_{g} preferably ranges from 0.27 to 0.62. The value of L_{CM}/λ_{g} more preferably ranges from 0.33 to 0.60 and particularly preferably ranges from 0.37 to 0.56.

When the dielectric substrate or the window glass sheet 9 has a dielectric constant of 6 to 8, and when the dielectric substrate or the window glass sheet 9 has a thickness of 1.8 to 5 mm, the shortening coefficient of wavelength of k is 0.40 to 0.70 for a radio wave for communication having a frequency of 200 MHz to 6 GHz, is 0.40 to 0.64 for a radio wave for communication having a frequency of 400 MHz to 6 GHz and is 0.40 to 0.55 for a radio wave for communication having a frequency of 1 to 6 GHz.

In the embodiment shown in FIG. 2, when N is a natural number, and when N varies from 1 to 4, the N-th independent conductor and the (N+4)-th independent conductor are disposed so as to be symmetrical or substantially symmetrical with each other about the antenna center. It is preferred in terms of improved antenna gain that each of the plural independent conductors have a symmetrically or substantially symmetrically disposed independent conductor in the present invention. However, the present invention is not limited to this mode. It is sufficient that at least one pair of independent conductors among the plural independent conductors is disposed so as to be symmetrical or substantially symmetrical with each other.

When an odd number of independent conductors are disposed in the present invention, it is preferred that half of the independent conductors in the amount of (the odd number—1) have symmetrically or substantially symmetrically disposed independent conductors. When the number of the independent conductors is two, it is preferred that the two independent conductors be disposed so as to be symmetrical or substantially symmetrical with each other about the antenna center.

In a case where one or more of the plural independent conductors except for independent conductor A and independent conductor B have a straight portion in the present invention, when it is assumed that there is the imaginary straight line 7, which connects between the center of the circle having a radius of R₁ and the center of the straight portion of the at least one independent conductor, it is preferred in terms of improved antenna gain that the angle α formed by the imaginary straight line 7 and the straight portion of the at least one independent conductor (for example, the fourth independent conductor 44 in FIG. 2) be 72 to 108 deg.

In a case where one or more of the plural independent conductors except for independent conductor A and independent conductor B have a curved portion, when it is assumed that there is an imaginary straight line, which connects between the center of the circle having a radius of R₁ and the center of the curved portion of the at least one independent conductor, and when it is assumed that there is an imaginary tangent to the curve portion of the at least one independent conductor at the center of the curved portion, it is preferred that the angle α formed by the imaginary straight line and the imaginary tangent be 72 to 108 deg.

One or more of the plural independent conductors except for independent conductor A and independent conductor B may comprise a band-like conductor, a substantially band-like conductor, an island-like conductor or the like. In a case where at least one of the independent conductors comprises an island-like conductor or the like, and where the at least one independent conductor is formed in a shape having a longitudinal direction, when it is assumed that there is an imaginary straight line connecting the center of the circle having the radius of R₁ and the center of the longitudinal direction of the at least one independent conductor, it is preferred in terms of improved antenna gain that the angle α formed by the imaginary straight line and the longitudinal direction be 72 to 108 deg.

The angle α more preferably ranges from 81 to 99 deg and particularly preferably ranges from 85 to 95 deg.

When an independent conductor comprises a linear conductor in the present invention, the independent conductor may be formed in a straight-line shape or a curved-line shape. Examples of the curved-line shape include a semicircular shape, a substantially semicircular shape, an arc shape and a substantially arc shape. When all independent conductors except for independent conductor A and independent conductor B are formed in a semicircular shape, a substantially semicircular shape, an arc shape or a substantially arc shape, it is preferred in terms of improved antenna gain that the center of an original circles, on which the semicircular shape, the substantially semicircular shape, the arc shape or the substantially arc shape is based, coincides or substantially coincides with the center of the above-mentioned circle having a radius of R₁.

In the embodiment shown in FIG. 2, the first to eighth, i.e., eight independent conductors 41 to 48 are clockwise disposed in the numerical order of the first to eighth on the window glass sheet 9. The respective centers of gravity of the first to eighth independent conductors 41 to 48 are called first to eighth centers of gravity. When it is assumed that there are imaginary straight lines, each of which connects between the center of the circle having a radius of R₁ and the center of gravity of each of the first to eighth centers of gravity, the respective imaginary straight lines are called first to eighth center-of-gravity lines. For example, the fourth center-of-gravity line corresponds to the imaginary straight line 7, which connects between the center of the circle having a radius of R₁ and the fourth center of gravity. When N is a natural number, and when N varies from 1 to 7, a smaller one of the angles formed by the N-th center of gravity and the (N+1)-th center of gravity, and a smaller one of the angles formed by the first center of gravity and the eighth center of gravity are 40.5 to 49.5 deg. For example, as shown in FIG. 2, a smaller one of the angles formed by the fourth center of gravity and the fifth center of gravity (i.e., the angle β, which is a smaller one of the angles formed by the straight line 7 and a straight line 17 connecting between the center of the circle having a radius of R₁ and the fifth center of gravity) is 40.5 to 49.5 deg.

In the embodiment shown in FIG. 2, each of the first to eighth independent conductors is formed a straight-line shape, the eighth independent conductor 48 extends in parallel or substantially parallel with the vehicle opening edge 21, and the eighth independent conductor 48 is disposed closer to the vehicle opening edge 21 than the fourth independent conductor 44. When the shortest distance between the antenna center and the vehicle opening edge 21 is (0.3 to 0.68)·λ₀ in such a configuration, it is preferred from the viewpoint of improving sight, making the planar antenna compact and reducing the cost that the eighth independent conductor 48 be omitted. In this case, the absence of the eighth independent conductor 48 does not have an adverse effect on the antenna gain since the vehicle opening edge 21 can act as a substitute for the eighth independent conductor 48.

When the mode in this case is rephrased, the first to seventh, i.e., seven independent conductor 41 to 47 may be clockwise disposed in the numerical order of the first to seventh on the window glass sheet 9. The respective centers of gravity of the first to seventh independent conductors 41 to 47 are called first to seventh centers of gravity. When it is assumed that there are imaginary straight lines, each of which connects between the center of the circle having a radius of R₁ and the center of gravity of each of the first to seventh centers of gravity, the respective imaginary straight lines are called first to seventh center-of-gravity lines. When N is a natural number, and when N varies from 1 to 6, a smaller one of the angles formed by the N-th center of gravity and the (N+1)-th center of gravity is 40.5 to 49.5 deg, and a smaller one of the angles formed by the first center of gravity and the seventh center of gravity is 81 to 99 deg. When it is assumed that there is an imaginary straight line, which connects between the first center of gravity and the seventh center of gravity, this imaginary straight line extends in parallel or substantially parallel with the vehicle opening edge 21, and the first independent conductor 41 is disposed closer to the vehicle opening edge 21 than the third independent conductor 43.

The embodiment shown in FIG. 1 is more helpful to improve sight, make the planar antenna compact and reduce the cost than the embodiment shown in FIG. 2. In the embodiment shown in FIG. 1, the number of independent conductors is set at three, bringing the antenna center closer to the vehicle opening edge 21 than the embodiment shown in FIG. 2.

In the present invention, it is preferred in terms of improved antenna gain that the second antenna wire 20 be disposed so as to be symmetrical or substantially symmetrical with the first antenna wire about the antenna center. However, the present invention is not limited to this mode. Even when the second antenna wire 20 is not disposed so as to be symmetrical or substantially symmetrical with the first antenna wire 10 about the antenna center, the planar antenna is operable.

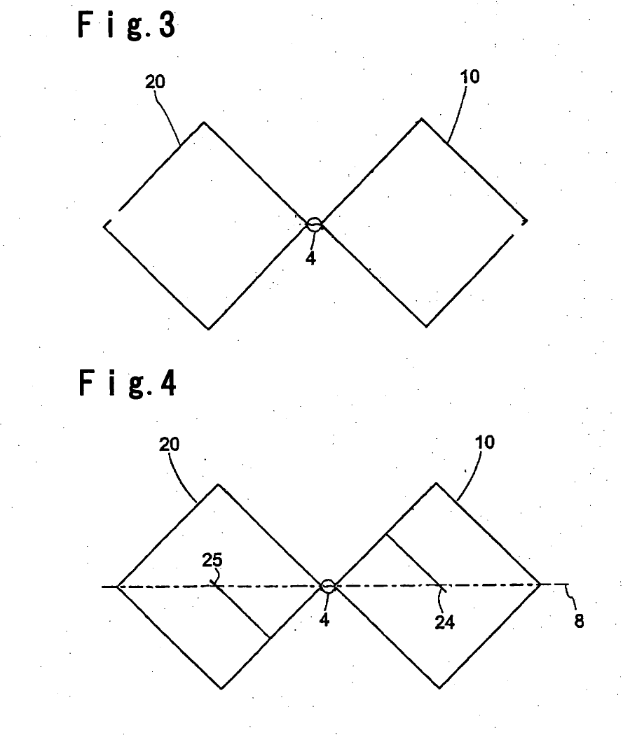

In the present invention, it is preferred that each of the first antenna wire 10 and the second antenna wire 20 comprise a complete loop wire for a circularly polarized wave as shown in FIG. 2. However, the present invention is not limited to this mode. As shown in FIG. 3, each of the antenna wires may comprise an incomplete loop wire having a portion removed by a certain length. It should be noted that no independent conductor is shown in FIG. 3 for simplification (which is also applicable to FIGS. 4 to 6 described later). The first antenna wire and the second antenna wire shown in each of FIGS. 3 to 6 may be used instead of the first antenna wire and the second antenna wire shown in each of FIGS. 1 and 2.

Each of the embodiments shown in FIGS. 1 and 2 is particularly favorable to make the planar antenna compact while each of the embodiments shown in FIGS. 3 to 6 is particularly helpful to improve the antenna gain.

Each of the first antenna wire 10 and the second antenna wire 20 shown in FIGS. 2 and 3 is formed in a square shape or a substantially square shape. It is preferred in terms of transmission and reception of a circularly polarized that each of the antenna wires be formed in such a shape. However, the present invention is not limited to this mode. The planar antenna is operable even when each of the antenna wires is formed in a triangular shape, a substantially triangular shape, a quadrangular shape, such as a rectangular shape, a substantially quadrangular shape, such as a substantially rectangular shape, a circular shape, a substantially circular shape, an elliptical shape, a substantially elliptical shape or the like.

The present invention may be configured so as to include not only means for capacitively coupling a first point of the first antenna wire 10 and a second point of the first antenna wire 10 except for the first point but also means for capacitively coupling a first point of the second antenna wire 20 and a second point of the second antenna wire 20 except for the first point. Specific examples of these means are the first capacitive coupling wire and the second capacitive coupling wire shown in FIG. 1 and 2.

In the following description, a combination of the first antenna wire 10 and the wire connected to the first antenna wire 10 (e.g., the first capacitive coupling wire in the embodiment shown in each of FIGS. 1 and 2) is called a first antenna, and a combination of the second antenna wire 20 and the wire connected to the second antenna wire 20 (e.g., the second capacitive coupling wire in the embodiment shown in each of FIGS. 1 and 2) are called a second antenna.

In order to simplify the following description, when the specifications for the shape and the dimensions in connection with only the first antenna are referred to, the specifications for the shape and the dimensions in connection with the first antenna are also applicable to the second antenna on the assumption that the first antenna and the second antenna have the same shape and dimensions or substantially the same shape and dimensions as each other.

In the embodiment shown in each of FIGS. 1 and 2, there is provided the first capacitive coupling wire, which comprises the paired coupling branch lines 1 and 2 connected to the first antenna wire 10 and extending inwardly from the first antenna wire 10. Additionally, the paired coupling branch lines 1 have open ends disposed close to each other so as to be capacitively coupled together. Since the paired coupling branch lines 1 and 2 are parallel to or in alignment with each other, the respective open ends of the paired coupling branch lines 1 and 2 are the closest portions of the paired coupling branch lines.

Although not shown in FIGS. 1 and 2, when the paired coupling branch lines 1 and 2 are not parallel with each other, the paired coupling branch lines 1 and 2 have the respective open ends disposed in the vicinity of the closest portions of the paired coupling branch lines 1 and 2, or of one of the paired coupling branch lines 1 and 2 has the open end disposed in the vicinity of the closest portion of the other coupling branch line.

Supposing that the paired coupling branch lines 1 and 2 extend beyond the respective open ends, it is preferred in terms of improved communication property that the paired coupling branch lines be positioned in such a positional relationship that the respective extensions collide with each other and connected to each other. However, the present invention is not limited to this mode. Even if none of the extensions collide with each other or be connected to each other since both extensions are out of alignment with each other, the planar antenna is operable as long as the open end of the coupling branch line 1 and the open end of the second coupling s branch line 2 are close to each other so as to be capacitively coupled together, and as long as the open end of the coupling branch line 1 and the open end of the second coupling branch line 2 are positioned at the closest portions since the paired coupling branch lines 1 and 2 are close to each other.

Although it is preferred in terms of improved communication property that the paired coupling branch lines 1 and 2 be in alignment with or substantially alignment with each other, the present invention is not limited to this mode. The planar antenna is operable even if the paired coupling branch lines 1 and 2 are out of alignment or out of substantially alignment with each other.

FIG. 4 shows the first antenna and the second antenna according to another embodiment, which is different from the embodiments shown in FIGS. 1 and 2. In FIG. 4, the dielectric substrate has a first antenna wire 10 in a loop shape and a second antenna wire 20 in a loop shape disposed so as to be close to each other. Additionally, the first antenna wire 10 has a first branch line 24 connected thereto so as to extend inward therefrom. No other branch line close to the first branch line 24 is disposed inside the first antenna wire 10. Additionally, the second antenna wire 20 has a second branch line 25 connected thereto so as to extend inward therefrom. No other branch line close to the second branch line 25 is disposed inside the second antenna wire 20.

In the embodiment shown in FIG. 4, the first branch line 24 and the second branch line 25 have open ends, respectively, which is preferred in terms of improved communication property of a circularly polarized wave. However, the present invention is not limited to this mode. The planar antenna is operable as long as at least one of the first branch line 24 and the second branch line 25 has an open end. In the embodiment shown in FIG. 4, the first branch line 24 and the second branch line 25 are symmetrical or substantially symmetrical with each other about the center of the transverse line 8, which is preferred in terms of improved communication property of a circularly polarized wave.

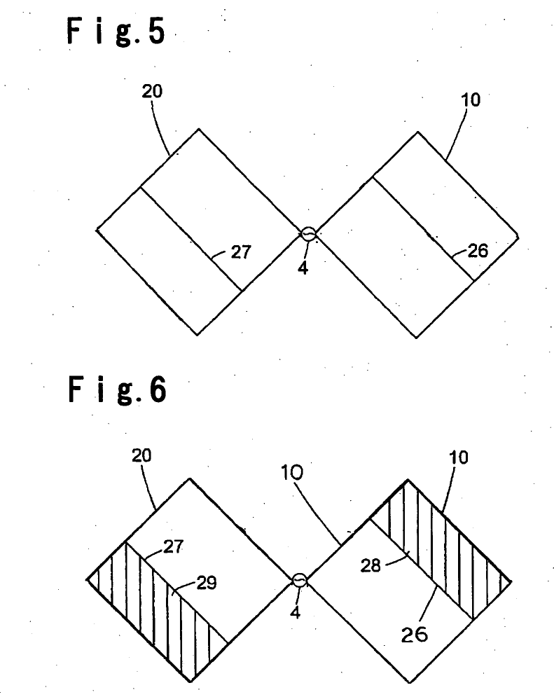

FIG. 5 shows the first antenna and the second antenna according to another embodiment, which is different from the embodiments shown in FIGS. 1 to 4. In FIG. 5, the dielectric substrate has a first antenna wire 10 in a loop shape and a second antenna wire 20 in a loop shape disposed so as to be close to each other. As shown in FIG. 5, there is disposed a first auxiliary line 26, which connects a first point of the first antenna wire 10 and a second point of the first antenna wire 10 except for the first point. There is also disposed a second auxiliary line 27, which connects a first point of the second antenna wire 20 and a second point of the second antenna wire 20 except for the first point. Both auxiliary lines are symmetrical or substantially symmetrical with each other about the antenna center, which is preferred in terms of improved communication property of a circularly polarized wave.

FIG. 6 shows the first antenna and the second antenna according to another embodiment, which is different from the embodiments shown in FIGS. 1 to 5. In the embodiment shown in FIG. 6, a first conductive film 28 is disposed in region A (which is a shaded area indicated by the leading edge of a lead line 28, although not being indicated by “A”), which is surrounded by a first antenna wire 10 and a first auxiliary line 26, and which has no contact with the closest portion of the first antenna wire 10. Additionally, a second conductive film 29 is disposed in region B (which is a shaded area indicated by the leading edge of a lead line 29, although not being indicated by “B”), which is surrounded by a second antenna wire 20 and a second auxiliary line 27, and which has no contact with the closes portion of the second antenna wire.

In consideration of improved productivity, it is preferred that the first antenna wire 10 and the first auxiliary line 26 be integrally formed with the first conductive film 28 in region A. It is also preferred that the second antenna wire 20 and the second auxiliary line 27 be also integrally formed with the second conductive film 29 in region B. It is preferred in terms of improved antenna gain that the first conductive film 28 and the second conductive film 29 be disposed in this way.

In the embodiment shown in FIG. 6, the conductive film is disposed in each of the entire portion of region A and the entire portion of region B, which is preferred in terms of improved antenna gain. However, the present invention is not limited to this mode. The planar antenna is operable as long as the conductive film is disposed in at least one portion of each of region A and region B.

In an another embodiment, a third conductive film is disposed in at least one portion of region C (a region other than region A), which is surrounded by the first antenna wire 10 and the first auxiliary line 26, and which has contact with the closest portion of the first antenna wire, and a fourth conductive film is disposed in at least one portion of region D (a region other than region B), which is surrounded by the second antenna wire 20 and the second auxiliary line 27, and which has contact with the closest portion of the second antenna wire 20.

In consideration of improved productivity, it is preferred that the first antenna wire 10 and the first auxiliary line 26 be integrally formed with the third conductive film in region C. Additionally, it is preferred that the second antenna wire 20 and the second auxiliary line 27 be integrally formed with the fourth conductive film in region D. It is preferred in terms of improved antenna gain that the third conductive film and the fourth conductive film be disposed in this way.

In this embodiment, it is preferred in terms of improved antenna gain that the conductive film be disposed in each of the entire portion of region C and the entire portion of region D. However, the present invention is not limited to this mode. The planar antenna is operable as long as the conductive film is disposed in at least one portion of each of region C and region D.

When the center between the closest portions of the first antenna wire 10 and the second antenna wire 20 is called the antenna center, the first antenna wire 10 and the second antenna wire 20 are disposed so that the center of gravity of the first antenna wire 10, the antenna center and the center of gravity of the second antenna wire 20 are in alignment or substantially in alignment with one another in the embodiments shown in FIGS. 1, 2 and 4 to 6.

In other words, in the embodiments shown in FIGS. 1 and 2, the first antenna wire 10 and the second antenna wire 20 are disposed so that the center of the first antenna wire 10, the antenna center and the center of the second antenna wire 20 are in alignment or substantially alignment with one another.

In the embodiments shown in FIGS. 1 and 2, it should be noted that the antenna center exists at the center of the shown power source 4. The closet portion of the first antenna wire 10 is the vertex of one of the angular corners of the first antenna wire 10, and the closest portion of the second antenna wire 20 is the vertex of one of the angular corners of the second antenna wire 20.

In the present invention, it is preferred in terms of improved antenna gain that a first feeding point be disposed at or in the vicinity of the closest portion of the first antenna wire 10, and that a second feeding point be disposed at or in the vicinity of the closest portion of the second antenna wire 20.

When the planar antenna according to the present invention is used as a receiving antenna, power is fed from the first antenna wire 10 and the second antenna wire 20. When the planar antenna according to the present invention is used as a transmitting antenna, power is fed to the first antenna wire 10 and the second antenna wire 20.

Power feeding means will be described in connection with the embodiments shown in FIGS. 1 to 6. In an example of the power feeding means, the central conductor of a coaxial cable (not shown) is connected to one of the first feeding point and the second feeding point by, e.g., soldering, and the outer conductor of the coaxial cable is connected to the other feeding point by, e.g., soldering. However, the present invention is not limited to this mode. The first power feeding point and the second power feeding point may be, respectively, connected to lead wires, power feeding pins or the like by, e.g., soldering, and the respective lead wires, the respective power feeding pins or the like may be connected to the central conductor and the outer conductor of the coaxial cable.

When the planar antenna according to the present invention is directly connected to a coaxial cable, lead wires, power feeding pins or the like, it is preferred that the feeding points be formed so as to make the line width of the first feeding point wider than the line width of the first antenna wire 10 and/or to make the line width of the second feeding point wider than the line width of the second antenna wire 20. This is effective to improve the reliability of connection.

In another example of the power feeding means, the first power feeding point is connected to a first power feeding line, the second power feeding point is connected to a second power feeding line, the central conductor of a coaxial cable is connected to one of the first and second power feeding lines by, e.g., soldering, and the outer conductor of the coaxial cable is connected to the other power feeding line by, e.g., soldering, although not shown.

The first and second power feeding lines may have respective feeding points provided thereon, and the respective feeding points may be connected to a coaxial cable, lead wires, power feeding pins or the like by, e.g., soldering, or make use of electromagnetic coupling. The present invention is not limited to this mode. Any power feeding means is applicable as long as it is possible to feed power.

FIG. 8 is a plan view of another embodiment, which is different from the embodiments shown in FIGS. 1 and 2. In FIG. 8, reference numeral 51 designates an antenna conductor, reference numeral 54 designates a power source, reference numeral 58 designates an imaginary endless transverse line, reference X₃ designates a point where the imaginary endless transverse line 58 passes through or extends over or under independent conductor A, reference X₄ designates a point where the imaginary endless transverse line 58 passes through or extends over or under independent conductor B, reference L₃ designates the shortest distance between the point X₃ and the antenna conductor 51, reference L₄ designates the shortest distance between the point X₄ and the antenna conductor 51, reference θ₃ designates a smaller one of the angles formed at the point X₃ by the imaginary endless transverse line 58 and a straight portion of independent conductor A, and reference θ₄ designates a smaller one of the angles formed at the point X₄ by the imaginary transverse line 58 and a straight portion of independent conductor B.

The antenna conductor 51 is disposed along with the two conductors, which are spaced from each other by a certain distance and are called independent conductor A and independent conductor B, respectively. The imaginary endless transverse line 58 is a line, which passes through the center of gravity of the antenna conductor 51 or the center of the antenna conductor 51 and extends in parallel with a longitudinal direction of the antenna conductor 51. Independent conductor A is disposed on one of both sides of the antenna conductor 51, and independent conductor B is disposed on the other side of the antenna conductor 51. Independent conductor A and independent conductor B are disposed on the window glass sheet 9 as the dielectric substrate so that the imaginary endless transverse line 51 passes through or extends over or under independent conductor A and independent conductor B. The longitudinal direction of the antenna conductor 51 means a direction having the maximum width.

The antenna conductor 51 shown in FIG. 8 is formed in a substantially angular C-character shape and has the propagation direction of an electric field, an antenna gain and no null point in the direction of the endless transverse line 58 (the longitudinal direction thereof). In this embodiment, the antenna conductor is not limited to be formed in a substantially angular C-character shape. The antenna conductor may be formed in an angular C-character shape, a U-character shape, a substantially U-character shape, a C-character shape, a substantially C-character shape or the like. The antenna conductor may be formed in any shape as long as the antenna conductor has such a shape and dimensions to have the propagation direction of an electric field, an antenna gain and no null point in the longitudinal direction thereof.

The endless transverse line 58 corresponds-to the endless transverse line 8a in the embodiment shown in FIG. 1. References X₃ and X₄ correspond to references X₁ and X₂ in the embodiment shown in FIG. 1. References L₃ and L₄ correspond to references L₁ and L₂ in the embodiment shown in FIG. 1. References θ₃ and θ₄ correspond to references θ₁ and θ₂ in the embodiment shown in FIG. 1. In other words, the conditions described in connection with the embodiment shown in FIG. 1 are also applied to the conditions in connection with references X₃, X₄, L₃, L₄, θ₃ and θ₄. It should be noted that the antenna conductor 51 functions as a monopole antenna.

The embodiment shown in FIG. 8 is appropriate to the 800 MHz band, the 1.5 GHz band, the 1.8 GHz band and the 1.9 GHz band for digital terrestrial television broadcasting and cellular phones, the 1.2 GHz band and the 1.5 GHz band for the GPS (Global Positioning System), and the Keyless Entry System for automobile (300 to 450 MHz).

In the present invention, conductor patterns for, e.g., the first antenna wire 10, the second antenna wire 20, the first capacitive coupling wire, the second capacitive coupling wire, the first feeding line and the second feeding line, may be normally fabricated by forming conductive patterns on a dielectric substrate, such as a circuit board.

When the planar antenna according to the present invention is configured as a glass antenna for a vehicle, a window glass sheet is used as the dielectric substrate, and the conductors of the planar antenna according to the present invention (the conductors disposed on the dielectric substrate, such as the antenna wires 10 and 20, the coupling branch lines 1 and 2, the independent conductors 41 to 48, the antenna conductor 51 and the power source 54) are normally formed by printing paste containing conductive metal, such as silver paste, on an interior surface of the window glass sheet and baking the paste. However, the present invention is not limited to this forming method. Linear members or foil-like members, which are made of a conductive substance, such as copper, may be formed on an interior surface or an exterior surface of the window glass sheet or in the window glass sheet per se.

The antenna device according to the present invention is appropriate to be employed in communication having a frequency band of 1 to 6 GHz and more appropriate to be employed in communication having a frequency band of 2.10 to 2.65 GHz. In other words, it is preferred that the frequency of a radio wave for communication contain a frequency ranging from 1 to 6 GHz. It is more preferred that the frequency of a radio wave for communication contain a frequency ranging from 2.10 to 2.65 GHz. The planar antenna according to the present invention is applicable to communication using a linearly polarized wave, such as a horizontally polarized wave and a vertically polarized wave for, e.g., a digital television, and communication using a circularly polarized wave, such as a satellite wave.

### EXAMPLE

Although the present invention will be described with reference to examples, the present invention will not be limited to these examples. Various variations or modifications are included in the present invention as long as the variations and modifications do not depart from the spirit of the invention. Now, the examples will be described in detail, referring to the accompanying drawings.

### Example 1 (Comparative Example)

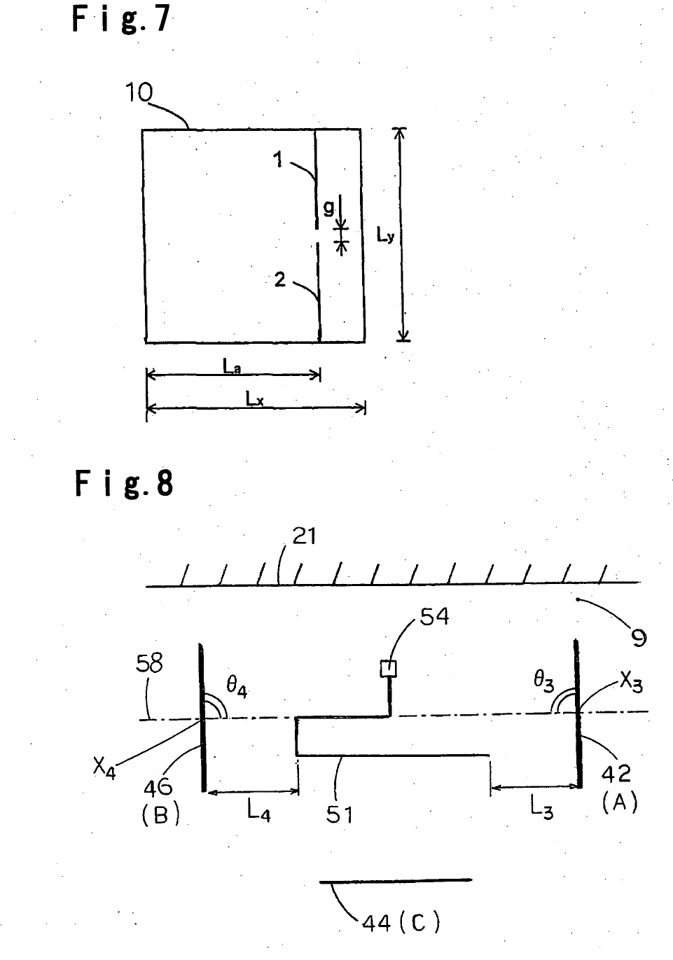

A planar antenna, which was configured in the same way as the planar antenna shown in FIG. 2 except that no independent conductors 41 to 48 were disposed (in the same way as the planar antenna shown in FIG. 7, although the second antenna wire 20 is not shown for simplification), was fabricated by disposing copper foil on the interior side surface of the rear window glass sheet for an automobile, and the planar antenna was measured. The operating frequency of this planar antenna was set at 2.38 GHz, and the used radio wave was a left-hand circularly polarized wave. The dimensions of the first antenna wire 10 are shown in FIG. 7. The dimensions of each element and the constants were listed below. The first antenna wire 10 and the second antenna wire 20 were disposed so as to be symmetrical about the antenna center.

| Thickness of rear window glass | 3.50 | mm |
|---|---|---|
| sheet | | |
| Dielectric constant of rear window | 7.0 | |
| glass sheet | | |
| Length of one side of square | 15.19 | mm |
| defined by first antenna wire 10 | | |
| (Lₓ= L_{y}) | | |
| Shortest distance Lₐ between | 12.15 | mm |
| coupling branch line 20 and | | |
| portion of first antenna wire 10 | | |
| closest to second antenna wire 20 | | |
| Shortest distance g between paired | 0.5 | mm |
| coupling branch line 1 and 2 | | |
| R₁ | 50.0 | mm |
| Shortest distance between vehicle | 80 | mm |
| opening edge 21 for a window and | | |
| antenna center | | |
| Frequency of radio wave | 2.38 | GHz |
| Line width of each of first | 0.4 | mm |
| antenna conductor 10, second | | |
| antenna wire 20 and coupling | | |
| branch lines 1 and 2 | | |

| | |
|---|---|
| Inclination of rear window glass | 26.0 |
| sheet to horizontal direction | |

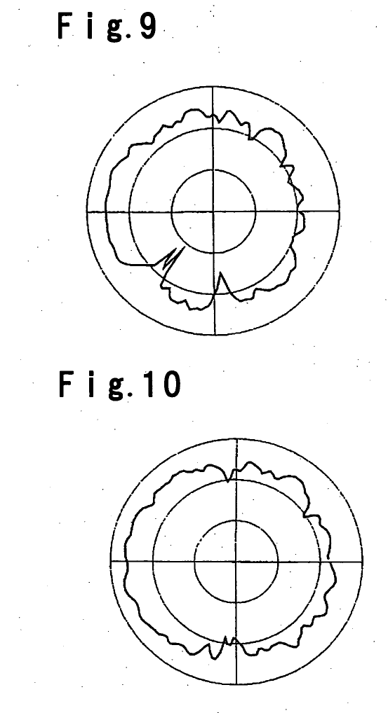

When the horizontal direction is defined as being an elevation angle of 0 deg, and when the zenith is defined as being an elevation angle of 90 deg, the directivity of the planar antenna was measured at an elevation angle of 60 deg on the rear side of the automobile as viewed from the antenna center. The measurement results are shown in FIG. 9.

A front side and a rear side of the automobile are shown on the portion in a right direction and the portion in a left direction portion in FIG. 9, respectively. In the directional pattern shown in FIG. 9, the center is graduated at −50 dB, the minimum circle is graduated at −30 dB, the second circle from the center is graduated at −10 dB, and the maximum circle (the outermost circle) is graduated at +10 dB. The specifications for FIG. 9 are also applicable to FIGS. 10 to 12.

With respect to the antenna gain shown in FIG. 9, the maximum value is 2.21 dB, and the minimum value is −25.96 dB. This means that the difference between the maximum value and the minimum value is 28.17 dB. It is revealed that the difference between the maximum value and the minimum value is too big for the planar antenna to be a non-directional antenna and that the antenna gain abruptly drops at null points.

### Example 2 (Example)

A planar antenna was fabricated in the same way as Example 1 except that the eight independent conductors 41 to 48 were disposed as shown in FIG. 2. The independent conductors 41 to 48 were disposed so as to have the same length as one another. The dimensions of each of the independent conductors 41 to 48 are listed below.

| | | |
|---|---|---|
| L₁ | 28.52 | mm |
| L₂ | 28.52 | mm |
| L₄₈ | 32.0 | mm |
| α | 90 | deg |
| β | 45 | deg |
| θ₁ | 90 | deg |
| θ₂ | 90 | deg |
| The line width of each of the | 0.4 | mm |
| independent conductors 41 to 48 | | |

The directivity was measured. The measurement results are shown in FIG. 10. With respect to the antenna gain shown in FIG. 10, the maximum value is 4.54 dB, and the minimum value is −12.95 dB. This means that the difference between the maximum value and the minimum value is 17.49 dB. It is revealed that the difference between the maximum value and the minimum value is enough small for the planar antenna to be close to a non-directional antenna and that the antenna gain is prevented from abruptly dropping at null points.

### Example 3 (Example)

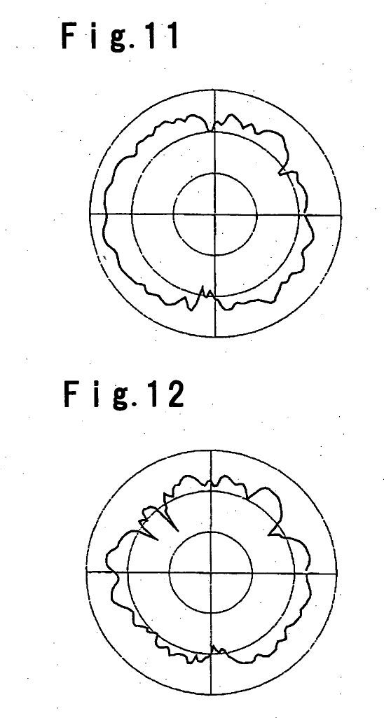

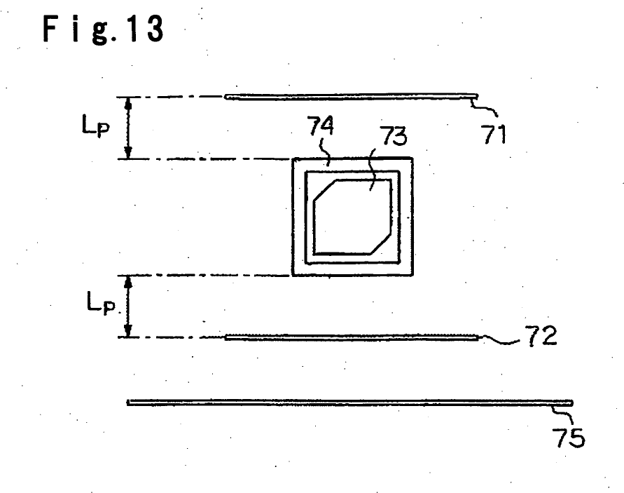

A planar antenna was fabricated in the same way as Example 2 except that the independent conductor 48 was not disposed. The directivity was measured. The measurement results are shown in FIG. 11. With respect to the antenna gain shown in FIG. 11, the maximum value is 4.46 dB, and the minimum value is −13.94 dB. This means that the difference between the maximum value and the minimum value is 18.4 dB. It is revealed that the difference between the maximum value and the minimum value is enough small for the planar antenna to be close to a non-directional antenna and that the antenna gain is prevented from abruptly dropping at null points.

### Example 4 (Example)

A planar antenna was fabricated in the same way as Example 2 except that none of the independent conductors 41, 43, 45, 47 and 48 was disposed (in other words, in the same way as the planar antenna shown in FIG. 1). The directivity was measured. The measurement results are shown in FIG. 12. With respect to the antenna gain shown in FIG. 12, the maximum value is 0.62 dB, and the minimum value is −22.48 dB. This means that the difference between the maximum value and the minimum value is 23.1 dB. It is revealed that the planar antenna is close to a non-directional antenna since the difference is smaller than Example 1.

As described, explanation of Examples 1 to 4 has been made. When the difference between the maximum value and the minimum value of the antenna gain in each of Examples 1 to 4 is called Z, and when respective Examples 1 to 4 have Z₁ to Z₄ in connection with Z, the difference between Z₁ and each of Z₁ to Z₄ is listed in Table 1.

TABLE 1

| | Difference Z₁ and each of Z₂ to Z₄ |
|---|---|
| Example 1 | — |
| Example 2 | 10.68 |
| Example 3 | 9.77 |
| Example 4 | 5.07 |

The planar antenna according to the present invention is applicable to communication using, e.g., a circularly polarized wave, such as the ETC or the SDARS (Satellite Digital Audio Radio System having a band of 2.1 to 2.65 GHz). The planar antenna according to the present invention is also applicable to various kinds of data communication, such as the DSRC (Dedicated Short Range Communication) using a frequency similar to the ETC system. The planar according to the present invention is also applicable to transmit and receive a radio wave for digital terrestrial television broadcasting (473 to 767 MHz); a radio wave in the 800 MHz band, the 1.5 GHz band, the 1.8 GHz band, and the 1.9 GHz band for cellular phones, and in the 1.2 GHz band and the 1.5 GHz band for the GPS; and a radio wave using a frequency of 2.5 GHz for the VICS (Vehicle Information and Communication System). The planar antenna according to the present invention is also applicable to transmit and receive a radio wave in the UHF band (300 MHz to 3 GHz) to transmit a radio wave in the Keyless Entry System for automobiles, and to transmit or receive a radio wave in a high frequency band (3 GHz to 30 GHz) and a millimeter-wave band (30 GHz to 300 GHz).

The entire disclosure of Japanese Patent Application No. 2005-281725 filed on Sep. 28, 2005 including specification, claims, drawings and summary is incorporated herein by reference in its entirety.

What is claimed is:

1. A planar antenna comprising:
a dielectric substrate having an antenna conductor disposed thereon or therein, the antenna conductor comprising a monopole antenna; and
two conductors, each of which is spaced from the antenna conductor by a distance, and which are called independent conductor A and independent conductor B, respectively;
wherein when an imaginary straight line, which passes through the center of gravity of the antenna conductor or the center of the antenna conductor and extends in parallel with a longitudinal direction of the antenna conductor, is called an endless transverse line;
the antenna conductor is formed in such a shape and a size to have an antenna gain in the longitudinal direction;
independent conductor A is disposed on one of both sides of the antenna conductor, and independent conductor B is disposed on the other side of the antenna conductor; and
independent conductor A and independent conductor B are disposed on or in the dielectric substrate so that the endless transverse line passes through independent conductor A and independent conductor B or extends over or under independent conductor A and independent conductor B.

2. A planar antenna comprising:
a dielectric substrate having a first antenna wire and a second antenna wire disposed thereon or therein so as to be close to each other, each of the first antenna wire and the second antenna wire being formed in a loop shape; and
two conductors, each of which is spaced from the first antenna wire and the second antenna wire by a distance, and which are called independent conductor A and independent conductor B, respectively;
wherein when it is assumed that there is a first imaginary straight line connecting between the center of gravity of the first antenna wire and the center of gravity of the second antenna wire or connecting between the center of the first antenna wire and the center of the second antenna wire, the first imaginary straight line is called a transverse line, and when it is assumed that there is a second imaginary line obtained by endlessly extending the transverse line, the second imaginary line is called an endless transverse line;
when the center between closest portions of the first antenna wire and the second antenna wire is called an antenna center,
independent conductor A is disposed on a side closer to the first antenna wire with respect to the antenna center;
independent conductor B is disposed on a side closer to the second antenna wire with respect to the antenna center; and
independent conductor A and independent conductor B are disposed on or in the dielectric substrate so that the endless transverse line passes through independent conductor A and independent conductor B or extends over or under independent conductor A and independent conductor B.

3. The planar antenna according to claim 2, wherein each of independent conductor A and independent conductor B has a straight portion or a curved portion at a position where the endless transverse line passes through independent conductor A or independent conductor B or extends over or under independent conductor A or independent conductor B;
a smaller one of the angles formed by the endless transverse line and the straight portion or an imaginary tangent to the curved portion of independent conductor A at the position is 72 to 108 deg; and
a smaller one of the angles formed by the endless transverse line and the straight portion or an imaginary tangent to the curved portion of independent conductor B at the position is 72 to 108 deg.

4. The planar antenna according to claim 2, wherein each of independent conductor A and independent conductor B is formed in a shape having a longitudinal direction;
a smaller one of the angles formed by the endless transverse line and the longitudinal portion of independent conductor A is 72 to 108 deg; and
a smaller one of the angles formed by the endless transverse line and the longitudinal portion of independent conductor B is 72 to 108 deg.

5. The planar antenna according to claim 2, wherein there is a position where the endless transverse line passes through independent conductor A or independent conductor B or extends over or under independent conductor A or independent conductor B; and
when the shortest distance between the position of independent conductor A and the first antenna wire is called L₁, the shortest distance between the position of independent conductor B and the second antenna wire is called L₂, and a radio wave for communication has a wavelength of λ₀ in air,
each of L₁ and L₂ is 10 mm to 0.51λ₀.

6. The planar antenna according to claim 2, wherein independent conductor A is formed in at least one of a straight-line shape and a curved-line shape, and
independent conductor B is formed in at least one of a straight-line shape and a curved-line shape.

7. The planar antenna according to claim 2, wherein independent conductor A and independent conductor B are disposed so as to be symmetrical with each other about the antenna center.

8. A planar antenna comprising:
a window glass sheet having a first antenna wire and a second antenna wire disposed thereon or therein so as to be close to each other, each of the first antenna wire and the second antenna wire being formed in a loop shape and being disposed in the vicinity of a vehicle opening edge for a window;
wherein when it is assumed that there is an imaginary straight line connecting between the center of gravity of the first antenna wire and the center of gravity of the second antenna wire or connecting between the center of the first antenna wire and the center of the second antenna wire, the imaginary straight line is called a transverse line;
the window glass sheet has independent conductor C disposed thereon or therein; independent conductor C is formed in a shape having a longitudinal direction; and independent conductor C, the first antenna wire and the second antenna wire are disposed so that each of the longitudinal direction of independent conductor C and the transverse line extends in parallel or substantially parallel with the vehicle opening edge for a window and that the first antenna wire and the second antenna wire are disposed between independent conductor C and the vehicle opening edge for a window.

9. The planar antenna according to claim 2, wherein the first antenna wire comprises an antenna wire, which has a capacitive coupling portion formed by cutting out a portion of a loop conductor by a length; and
the second antenna wire comprises an antenna wire, which has a capacitive coupling portion formed by cutting out a portion of a loop conductor by a length.

10. The planar antenna according to claim 8, wherein in a case where the center between closest portions of the first antenna wire and the second antenna wire is called an antenna center;
when it is assumed that there is an imaginary circle having a radius of R₁ about the antenna center, and when a radio wave for communication has a wavelength of λ₀ in air,
independent conductor C has a portion or the entire portion disposed in a doughnut-like region having a radius of R₁=(0.3 to 0.68)·λ₀; and
the vehicle opening edge for a window exists in the doughnut-like region having a radius of R₁=(0.3 to 0.68)·λ₀.

11. The planar antenna according to claim 2, further comprising plural conductors, which are spaced from the first antenna wire and the second antenna wire:
wherein in a case where the plural conductors are called independent conductors, and where the center of closest portions of the first antenna wire and the second antenna wire is called an antenna center;
two of the plural independent conductors comprises independent conductor A and independent conductor B; and
when it is assumed that there is an imaginary circle having a radius of R₁ about the antenna center, and when a radio wave for communication has a wavelength of λ₀ in air,
at least one of the plural independent conductors except for independent conductor A and independent conductor B has a portion or the entire portion disposed in a doughnut-like region having a radius of R₁=(0.3 to 0.68)·λ₀.

12. The planar antenna according to claim 11, wherein at least one of the plural independent conductors has a main portion, the entire portion, the center or the center of gravity disposed in a doughnut-like region having a radius of R₁=(0.3 to 0.68)·λ₀.

13. The planar antenna according to claim 11, wherein in a case where at least one of the plural independent conductors is formed in a linear shape, when the at least one independent conductor has a conductor length of L_{C}, when the dielectric substrate comprises a material having a shortening coefficient wavelength of k, and when the formula of λ_{g}=λ₀·k is established;
the formula of L_{C}/λ_{g}=0.2 to 0.65 is established with respect to one or more of the independent conductors.

14. The planar antenna according to claim 11, wherein in a case where at least one of the plural independent conductors includes a portion formed in a shape except for the linear shape, when one or more of the independent conductors have a maximum width of L_{CM}, when the dielectric substrate comprises a material having a shortening coefficient wavelength of k, and when the formula of λ_{g}=λ₀·k is established;
the formula of L_{CM}/λ_{g}=0.2 to 0.65 is established with respect to one or more of the independent conductors.

15. The planar antenna according to claim 11, wherein the plural independent conductors include at least one pair of independent conductors disposed so as to be symmetrical with each other about the antenna center.

16. The planar antenna according to claim 11, wherein one or more of the plural independent conductors have a straight portion; and
wherein when it is assumed that there is an imaginary straight line connecting between the center of the circle having a radius of R₁ and the center of the straight portion of the at least one independent conductor, an angle α formed by the straight line and the straight portion of at least one of the independent conductors is 72 to 108 deg.

17. The planar antenna according to claim 11, wherein one or more of the plural independent conductors have a curved portion; and
wherein when it is assumed that there is an imaginary straight line connecting between the center of the circle having a radius of R₁ and the center of the curved portion of at least one of the independent conductors, and when it is assumed that there is an imaginary tangent to the curve portion of the at least one independent conductor at the center of the curved portion, an angle α formed by the imaginary straight line and the imaginary tangent is 72 to 108 deg.

18. The planar antenna according to claim 11, wherein one or more of the plural independent conductors except for independent conductor A and independent conductor B are formed in a shape having a longitudinal direction; and
wherein when it is assumed that there is an imaginary straight line connecting between the center of the circle having a radius of R₁ and the center of the longitudinal direction of the at least one independent conductor, an angle α formed by the imaginary straight line and the longitudinal direction is 72 to 108 deg.

19. The planar antenna according to claim 11, wherein one or more of the plural independent conductors except for independent conductor A and independent conductor B are formed in a semicircular shape, a substantially semicircular shape, an arc shape or a substantially arc shape, and the center of an original circle, on which the semicircular shape, the substantially semicircular shape, the arc shape or the substantially arc shape is based, coincides or substantially coincides with the center of the circle having a radius of R₁.

20. The planar antenna according to claim 2, wherein first to eighth independent conductors are clockwise disposed in a numerical order of the first to eighth on or in the dielectric substrate;
independent conductor A comprises the second independent conductor;
independent conductor B comprises the sixth independent conductor; and
wherein when the respective centers of gravity of the first to eighth independent conductors are called first to eighth centers of gravity, when it is assumed that there are imaginary straight lines, each of which connects between the center of the circle having a radius of R₁ and each of the first to eighth centers of gravity, the respective imaginary straight lines are called first to eighth center-of-gravity lines, when N is a natural number, and when N varies from 1 to 7;
a smaller one of the angles formed by the N-th center of gravity and the (N+1)-th center of gravity, and a smaller one of the angles formed by the first center of gravity and the eighth center of gravity are 40.5 to 49.5 deg.

21. The planar antenna according to claim 2, wherein the dielectric substrate comprises a window glass sheet for an automobile;
first to seventh of seven independent conductors are clockwise disposed in a numerical order of the first to seventh on the window glass sheet as viewed from a car-interior side or a car-exterior side;
independent conductor A comprises the second independent conductor;
independent conductor B comprises the sixth independent conductor; and
wherein when the respective centers of gravity of the first to seventh independent conductors are called first to seventh centers of gravity, when it is assumed that there are imaginary straight lines, each of which connects between the center of the circle having a radius of R₁ and each of the first to seventh centers of gravity, the respective imaginary straight lines are called first to seventh center-of-gravity lines, when N is a natural number, and when N varies from 1 to 6;
a smaller one of the angles formed by the N-th center of gravity and the (N+1)-th center of gravity is 40.5 to 49.5 deg; and
a smaller one of the angles formed by the first center of gravity and the seventh center of gravity is 81 to 99 deg;
wherein when it is assumed that there is an additional imaginary straight line connecting between the first center of gravity and the seventh of center of gravity, the additional imaginary straight line and a vehicle opening edge for a window are parallel or substantially parallel with each other, and the first independent conductor is disposed closer to the vehicle opening edge for a window than the third independent conductor.

22. The planar antenna according to claim 2, wherein each of the first antenna wire and the second antenna wire is formed in a triangular shape, a substantially triangular shape, a quadrangular shape, a substantially quadrangular shape, a circular shape, a substantially circular shape, an elliptical shape or a substantially elliptical shape.

23. The planar antenna according to claim 2, wherein each of the first antenna wire and the second antenna wire is formed in a square shape or a substantially square shape.

24. The planar antenna according to claim 2, further comprising:
means for capacitively coupling a first point of the first antenna wire and a second point of the first antenna wire except for the first point of the first antenna wire; and
means for capacitively coupling a first point of the second antenna wire and a second point of the second antenna wire except for the first point of the second antenna wire.

25. The planar antenna according to claim 2, further comprising:
a first capacitive coupling wire comprising a pair of coupling branch lines connected to the first antenna wire and extending inwardly from the first antenna wire, the paired coupling branch lines having open ends disposed so as to be capacitively coupled together;
wherein when the paired coupling branch lines are parallel to or in alignment with each other, the respective open ends of the paired coupling branch lines are closest portion thereof;
when the paired coupling branch lines are not parallel to each other, the paired coupling branch lines have open ends disposed in the vicinity of closest portions of the paired coupling branch lines, or one of the paired coupling branch lines has the open end disposed in the vicinity of the closest portion of the other coupling branch line; and
further comprising
a second capacitive coupling wire comprising a pair of coupling branch lines connected to the second antenna wire and extending inwardly from the second antenna wire, the paired coupling branch lines having open ends disposed so as to be capacitively coupled together;
wherein when the paired coupling branch lines are parallel to or in alignment with each other, the respective open ends of the paired coupling branch lines are closest portion thereof;
when the paired coupling branch lines are not parallel to each other, the paired coupling branch lines have open ends disposed in the vicinity of closest portions of the paired coupling branch lines, or one of the paired coupling branch lines has the open end disposed in the vicinity of the closest portion of the other coupling branch line.

26. The planar antenna according to claim 2, further comprising:
a first branch line connected to the first antenna wire and extending inwardly from the first antenna wire, the first antenna wire having no additional branch line close to the first branch line and extending inwardly from the first antenna wire;
a second branch line connected to the second antenna wire and extending inwardly from the second antenna wire, the second antenna wire having no additional branch line close to the second branch line and extending inwardly from the second antenna wire; and
both of the first branch line and the second branch line having open ends.

27. The planar antenna according to claim 2, which is used for a circularly polarized wave, further comprising:
a first auxiliary line connecting between a first point of the first antenna wire and a second point of the first antenna wire except for the first point of the first antenna wire; and
a second auxiliary line connecting between a first point of the second antenna wire and a second point of the second antenna wire except for the first point of the second antenna wire;
wherein the first auxiliary line and the second auxiliary line are symmetrical with each other about the antenna center.

28. The planar antenna according to claim 27, further comprising:
a conductive film disposed in at least one portion of a region, which is surrounded by the first antenna wire and the first auxiliary line, and which has no contact with the closest portion of the first antenna wire, and
a conductive film disposed in at least one portion of a region, which is surrounded by the second antenna wire and the second auxiliary line, and which has no contact with the closest portion of the second antenna wire.

29. The planar antenna according to claim 27, further comprising:
the first antenna wire having a first feeding point therein, and the second antenna wire having a second feeding point therein;
a conductive film disposed in at least one portion of a region, which is surrounded by the first antenna wire and the first auxiliary line, and which has contact with the first feeding point, and
a conductive film disposed in at least one portion of a region, which is surrounded by the second antenna wire and the second auxiliary line, and which has contact with the second feeding point.

30. The planar antenna according to claim 2, further comprising:
a first feeding point disposed at the closest portion of the first antenna wire or in the vicinity of the closest portion of the first antenna wire; and
a second feeding point disposed at the closest portion of the second antenna wire or in the vicinity of the closest portion of the second antenna wire.

31. The planar antenna according to claim 2, wherein when the planar antenna is used as a receiving antenna, power is fed from the first antenna wire and the second antenna wire; and
wherein when the planar antenna is used as a transmitting antenna, power is fed to the first antenna wire and the second antenna wire.

32. The planar antenna according to claim 1, wherein the antenna conductor is formed in an angular C-character shape, a substantially angular C-character shape, a U-character shape, a substantially U-character shape, an C-character shape, or a substantially C-character shape.

33. The planar antenna according to claim 2, which is used for a radio wave for communication, containing a frequency ranging from 1 to 6 GHz.

34. The planar antenna according to claim 2, which is used for a radio wave for communication, containing a frequency ranging from 2.10 to 2.65 GHz.

35. A window glass sheet for an automobile, comprising a dielectric substrate, the dielectric substrate having the planar antenna defined in claim 2 disposed thereon or therein.
